(19) United States
(12) Patent Application Publication
(10) Pub. No.: US 2018/0007741 A1
(43) Pub. Date: Jan. 4, 2018

(54) HEATER ELEMENT, DEVICE PROVIDED THEREWITH AND METHOD FOR MANUFACTURING SUCH ELEMENT

(71) Applicant: Metalmembranes.com B.V., Leeuwarden (NL)

(72) Inventors: Sybrandus Jacob Metz, Heerenveen (NL); Gerhard Hendrik Mulder, Weesp (NL); Johannes Kuipers, Leeuwarden (NL); Hans Hendrik Wolters, Leeuwarden (NL)

(73) Assignee: Metalmembranes.com B.V., Leeuwarden (NL)

(21) Appl. No.: 15/540,412

(22) PCT Filed: Dec. 29, 2015
(86) PCT No.: PCT/NL2015/050918

§ 371 Date: Jun. 28, 2017

(30) Foreign Application Priority Data
Dec. 31, 2014 (NL) 2014079

(51) Int. Cl. H05B 3/28; H05B 1/02; H05B 6/36; H05B 6/06; H05B 6/10; H05B 3/52; A24F 47/00

(52) U.S. Cl. CPC H05B 3/283; H05B 6/108; H05B 1/0216; H05B 3/52; H05B 6/362; H05B 6/065; A24F 47/008; H05B 2203/021; H05B 2203/022

(57) ABSTRACT

The present specification relates to heater element, device provided therewith and method for manufacturing such heater element. The heater element comprises a heater of a resistance heating metal that is provided in, at or close to a fluid path configured for heating fluid, wherein the heater comprises a conductor that is provided with a porous ceramic layer. In embodiments, the ceramic layer is provided on or at the conductor with plasma electrolytic oxidation. The ceramic layer has a thickness in the range of 5-300 μm.

### CROSS REFERENCE TO RELATED APPLICATIONS

The present specification is a National Phase Entry of International Application No. PCT/NL2015/050918 filed 29 Dec. 2015 and entitled “HEATER ELEMENT, DEVICE PROVIDED THEREWITH AND METHOD FOR MANUFACTURING SUCH ELEMENT” which, itself, claims priority to NL 2014079 filed 31 Dec. 2014 and entitled “HEATER ELEMENT, DEVICE PROVIDED THEREWITH AND METHOD FOR MANUFACTURING SUCH ELEMENT,” each of which are incorporated by reference herein in their entireties.

### FIELD

The present specification relates to a heater element that can be implemented in devices to heat fluids, such as water in a water cooker, E-liquids in E-cigarettes etc.

### TECHNICAL BACKGROUND

Heating fluids requires providing energy to the fluid. This can be achieved with a heater element, for example a resistance heating element. Such resistance heating element provided energy to the fluid by resistive heating, also referred to as Joule heating and Ohmic heating. Resistive heating is a process wherein electric current is applied to the conductive element that in response releases heat. Such conductive element is referred to as conductor. The released heat is used to heat the fluid. This process is known from conventional cookers for tea making, for example. Another example for a resistance heating element can be found in delivery systems, such as E-cigarettes. These systems comprise an inhaling device with an inlet and an outlet that is shaped as a mouth piece. E-cigarettes further comprise a battery and a heater that is provided with energy from the battery. The heater is wound around a so-called wicking material that acts as a buffer, wherein the heater is switched on and off with a flow detector located in the inlet, for example. A buffer comprises the delivery fluid, such as a so-called E-liquid, usually being a mixture of propylene glycol, glycerine, nicotine, and flavourings. The heater vaporises and/or atomises the E-liquid to enable inhaling of the liquid. Furthermore, using conventional heater elements may result in release of heavy metals, for example in E-cigarettes.

A problem with conventional heater elements is the insufficient control of heater temperature when the heater is in use. This often results in vaporizing and/or atomising of the fluid, such as water and E-liquid, with a relatively large temperature variation. This may even result in components in the E-liquid that are not only heated, but are burnt instead. This provides undesirable components in the inhaled fluid that could pose a problem in relation to a person's health. Furthermore, most conventional E-cigarettes have a buffer embodied as a type of cloth that comprises the E-liquid. Also burning this buffer material may result in undesirable components being inhaled by the person using the E-cigarette. Furthermore, it is known that heater elements are very sensitive to scaling or fouling, including calcification of the element.

### SUMMARY

The present specification has for its object to provide a heater element that enables a more controllable heating of fluids thereby reducing and/or preventing the aforementioned problems.

This object is achieved with the heater element according to the present specification, in which:
a heater of a resistance heating metal that is provided in, at or close to a fluid path configured for heating fluid,
   wherein the heater comprises a conductor that is provided with a porous ceramic layer.

The heater element comprises a conductor that can be shaped as a plate, wire, foil, tube, foam, rod or any other suitable shape, which, in embodiments, is formed from a so-called resistance heating material. The resistance heating element provides energy to the fluid by resistive heating, also referred to as Joule heating and Ohmic heating. This involves applying electric current to the conductor acting as conductive element that in response releases heat. The released heat is used to heat the fluid. The fluid can include water (for tea or coffee making, for example) and E-liquids (for E-cigarettes, for example). It will be understood that the heater element can also be applied to other fluids. In one of the embodiments according to the specification the conductor has a plate shape that on one side is provided with a ceramic layer. Optionally, the metal layer is (partly) removed, for example using electrochemical machining. This enables control of the thickness of the metal layer such that the electric resistance and heat production can be adapted to the needs for the specific system or device wherein the heater element is or will be used.

The conductor can be of a suitable material, capable of acting as a resistance heating material for resistive heating, including aluminium, FeAl, NiC, FeCrAl (Kanthal), titanium, and their alloys. Especially the use of the metal titanium provides good results.

According to the present specification the conductor is provided with a porous ceramic layer. The ceramic layer that is provided on or adjacent the conductor enables effective control of heater temperature. This prevents burning of components in the delivery fluid and/or other elements of the system, such as buffer material, for example. In this example, this improves the quality of the inhaled fluid by preventing undesirable components being present therein.

Furthermore, effective control of heater temperature prevents overheating and the heater element reaching a temperature that is higher than actually required. Such higher temperature increases the scaling and fouling rate of the heater element, including the calcification rate of the heater element. Therefore, the effective (temperature) control with the heater element according to the present specification reduces maintenance efforts and/or increases the lifetime of the heater element.

As a further effect the ceramic layer provides structure and stability to the conductor thereby increasing the strength and stability of the heater element as a whole. This is especially relevant in case the heater element is applied in consumer products, such as cookers, coffee machines and E-cigarettes. These products are typically subjected to many movements, vibrations and/or other impacts. For example, the increased stability prevents malfunctioning and/or prevents contact of the heater with other components of the product.

Furthermore, providing the heater element with a porous ceramic layer has as a further advantageous effect that in case of liquid cooking, for example tea making, the pores in the ceramic layer acts as starting points for the boiling process resulting in more and smaller bubbles at similar conditions as compared to conventional heaters. This improves the boiling process and, furthermore, significantly reduces the noise level of the boiling process. In other words, surprisingly, the porous ceramic layer has an acoustic reducing effect on the boiling process. Also, the ceramic layer enables adsorption and/or adsorption of liquid, such as E-liquids in the pores of the ceramic layer.

It may seem counterintuitive to use a ceramic for the heater element, as ceramics are known to be thermal insulators, or at least poor thermal conductors. Surprisingly however, the ceramic layer does have a positive effect on the heating process. It has now been found that the ceramic layer is able to even out spikes in the temperature of the conductor, thereby preventing burning of the liquid, for example. Importantly, the pores of the ceramic layer allow the fluid to come close to the electrical conductor, i.e. the pores can be said to reduce the effective thickness of the layer from a thermal point of view. Therefore, the pores mitigate the negative effect on the heat transfer of the normally poorly conducting ceramic. Moreover, the pores increase the contact surface between the ceramic and the delivery fluid, thereby further enhancing the heat transfer from the heater to the fluid. Therefore, the porous ceramic layer achieves an effective heating of the fluid for vaporizing and/or atomising thereof, even though the ceramic material in itself is a poor thermal conductor. More specifically, in specific embodiments of the heater element according to the present specification the ceramic layer absorbs/adsorbs liquid to be heated and evaporation/atomization occurs at least partly in the ceramic layer. A further advantage of the heater element according to the specification is the reduction of scaling or water scaling. Another further advantage is the advantageous use of the heater element according to the specification for heating gases due to the corrosion resistance and the insulation by the oxidation layer. This renders the heater element effective for an iron, for example.

In embodiments according to the present specification the ceramic layer has a thickness in the range of 5-300 μm, preferably 10-200 μm, more preferably 15-150 μm and most preferably a thickness is about 100 μm.

By providing the ceramic layer with a sufficient thickness the stability and strength of the heater is improved. Furthermore, the insulation is increased, enabling control of heat transfer and/or heat production. The thickness of the ceramic layer is adapted to the desired characteristics. This flexibility during production provides a further advantage of the system according to the present specification.

In one embodiment according to the specification, the ceramic layer is provided on or at the conductor with plasma electrolytic oxidation.

The heater element is preferably made from an aluminium material, or other suitable material, such as titanium, on which a porous metal oxide layer, such as aluminium oxide or titanium oxide, is grown with plasma electrolytic oxidation. Plasma electrolytic oxidation enables a relatively thick aluminium, titanium or other suitable metal layer is grown from the metal (>130 μm) by oxidizing (part of) the metal to metal oxide. Especially the use of titanium provides good results. The resulting layer is a porous, flexible and elastic metal oxide ceramic. Plasma electrolytic oxidation (>350-550 V) requires much higher voltage compared to standard anodizing (15-21 V). At this high voltage, micro discharge arcs appear on the surface of the aluminium, or other material, and cause the growth of the thick (metal) oxide layer. Results have shown that a ceramic layer can be achieved on an aluminium foil of about 13 μm thickness, with a flexible and elastic ceramic layer. One of the advantageous effects of using plasma electrolytic oxidation to provide the ceramic layer is that due to the growth of the layer from the metal during oxidation the adherence of the ceramic layer to the metal is excellent.

In embodiments the structure of the heating element comprises a thin wire of titanium, aluminium, or any other valve metal, such as magnesium, zirconium, zinc, niobium, vanadium, hafnium, tantalum, molybdenum, tungsten, antimony, bismuth, or an alloy of one or more of the preceding metals. The wire is coated on the other side through plasma electrolytic oxidation. Plasma electrolytic oxidation is done by placing the titanium wire in an electrolyte. For example, the electrolyte comprises 15 g/l (NaPO₃)₆ and 8 g/l Na₂SiO₃.5H₂O. The electrolyte is maintained at a temperature of 25° C. through cooling. The wire is used as an anode and placed in a container containing the electrolyte. Around the wire a stainless steel cathode is positioned. A current density is maintained between the wire and cathode of about 0.15 A/cm². The current is applied in a pulsed mode of about 1000 Hz. The current increases rapidly to about 500 Volt between the wire and the cathode. This creates a plasma electrolytic oxidation process on the anode wire and creates a ceramic layer. As the wire is small sized (100 micron) it has a relative high electrical resistance 61 Ohm/m. In use, by applying a current to the wire, the wire heats up. It will be understood that process parameters may depend on the structure of the heating element and/or the dimensions thereof.

In an alternative embodiment a plate of metal, for example aluminium, titanium or other valve metal, is coated on at least one side with a ceramic layer using plasma electrolytic oxidation, for example. Due to metal plate resistance its temperature increases when a current is applied. Also, a structure can be etched into the metal providing metal strips of metal having a relatively high resistance. The etching can be performed using electrochemical machining, for example.

Alternative manufacturing methods for the heater element include sintering or spark plasma sintering, oxidation of the surface layer of the metal by heating in oxygen rich environment, anodizing, and plasma spraying. Also, it would be possible to deposit an aluminium, or other material, coating on the conductor of the heater element, for example with arc spraying, and to oxidize the deposited material to an oxide with plasma electrolytic oxidation.

In embodiments according to the present specification, the heater comprises a spiralled metal wire as the conductor with the wire being provided with the ceramic layer.

Providing the heater with a spiralled metal wire an effective atomisation and/or vaporisation of the fluid can be achieved. It was shown that when the spiralled metal wire is preferably provided in the fluid path of an E-cigarette, this achieves an effective heating of the E-fluid.

Alternative configurations for the heater in a wire configuration include a straight wire, single or multiple layer solenoid wire, toroid single or multiple layer, and flat coil. Alternative configurations for the heater in a foil or plate configuration include a flat, round, rectangular shape, spiral wound, and folded configuration. Further alternative configuration for the heater in a tube configuration include a metallic tube with coated porous ceramic layer and optionally provided with a (static) mixing structure or helix structure, tube shape of foil/plate, and spiral wound foil/plate. An even further alternative configuration of the heater in a foam configuration includes a sponge structure.

In an embodiment according to the present specification the central axis, or longitudinal direction of the spiralled metal wire, is positioned substantially transversally to the main fluid flow direction in a fluid path.

In embodiments according to the present specification the spiralled heater has a central axis that is provided substantially in a longitudinal direction of a fluid path. Even more preferably, the fluid path is designed such that fluid to be heated passes through the spiralled wire in the longitudinal direction. This enhances the heating of the fluid, if relevant including atomisation and/or vaporisation, thereby improving control of these processes and/or reducing the amount of the required energy to perform these processes. This improves the lifetime of the system according to the present specification.

In embodiments the ceramic layer is provided with a porosity.

A porous ceramic layer is capable of providing stability and structure to the conductor. Furthermore, heat can be transferred from the conductor to the fluid surrounding the heater element.

The pores of the ceramic layer constitute an effective starting point for evaporation when boiling liquid. This improves the performance of a device for boiling water, such as a cooker or water cooker, that is provided with one or more heater elements according to the present specification.

By providing a porous ceramic layer it is possible to configure the ceramic layer such that, when the heater element is applied in an E-cigarette, delivery fluid is transferred through or along the ceramic layer enabling delivery fluid to transfer from a buffer to the conductor. This prevents the need to provide a separate buffer such as a buffer cloth.

In embodiments, the ceramic layer has a porosity in the range of 10-80%, preferably 15-50%, more preferably 20-30% and most preferably the porosity is about 25%. It was shown that especially the porosity in a range of 20-30% provides a optimum in the performance of specifically the ceramic layer and the heater as a whole. Furthermore, it is shown that using plasma electrolytic oxidation to provide the ceramic layer is beneficial in that it enables control of the porosity of the produced layer.

In embodiments according to the present specification the system further comprises a power increasing circuit configured for providing a power increase when the heater is switched on.

By providing the power increasing circuit the power can temporarily be increased when switching on the heater. Such circuit may comprise a number of capacitors and/or coils, with the number being one or more. The circuit enhances the effect of the heater and/or reduces the requirements for the power supply.

The present specification also relates to an (electrically) insulated conductor comprising a metal conductor that is provided with a ceramic layer as an electrically insulated layer.

The conductor provides the same effects and advantages as those described for the heater element. Preferably, the metal conductor comprises an aluminium wire having an oxide coating as electric insulator. Insulated conductors according to the specification can be used as insulated electric wiring.

The present specification also relates to a device comprising a heater element as described herein.

The device provides the same effects and advantages as described for the heater element. Examples of such devices include an E-cigarette, a (water) cooker for boiling liquid, a coffee machine, a knife, and an iron.

In an E-cigarette, providing a fluid path from the inlet to the outlet, preferably embodied as a mouth piece, enables inhaling at the outlet to draw/suck in ambient air, for example. The heater atomises and/or vaporizes the delivery fluid when the heater is switched on. Switching on the heater can be achieved with the use of a flow controller close to the inlet, for example. Energy is provided to the heater, by an energy source, for example a (rechargeable) battery. The delivery fluid can relate to a mixture of liquids and/or solids, including so-called E-liquids that may comprise a mixture of propylene glycol, glycerine, nicotine and flavourings. It will be understood that other ingredients can also be applied and/or nicotine can be omitted from the mixture. The heater element according to the present specification provides an effective temperature control of the heating process preventing burning of components and/or reduction of the amount of energy that is used.

In a cooker for boiling liquid such as water, the heater element according to the specification can be implemented to achieve a boiling process. The heater element can be embodied as a wire or ceramic plate with metal strip on a ceramic foil that are preferably subjected to plasma electrolytic oxidation. Plasma electrolytic oxidation produces a ceramic layer, preferably substantially all over the wire. The thickness of this ceramic layer can be controlled by the duration of the process. Because the ceramic layer is an insulator for electricity it can be placed into water. When an electric current is passed through the conductor, such as a thin titanium layer or wire, it heats up and transfers energy to the liquid. This enables boiling the water. The advantage of such a heating element is that it prevents the formation of large gas bubbles. Therefore, less noise is created during the boiling process. Also scaling is prevented or at least reduced on the heating element.

A coffee machine can be provided with a heater element according to the present specification. The heater element may comprise a titanium tube, although other suitable materials and shapes may also be applied. In one embodiment, on the inner side of a titanium tube, or any other valve metal, a ceramic layer is provided, preferably through plasma electrolytic oxidation. When an electric current is applied to the tube, due to the small thickness of the tube wall the tube has a high resistance and will be heated. Liquid inside the tube will be heated and, if necessary, will be brought to boiling conditions. In an alternative embodiment, a ceramic coating is provided on the outside of the conductor and can be inserted in a tube, vessel or other element. By applying an electric current liquid can be brought to boiling conditions. It is noted that a conductor, for example embodies as a wire or plate can also be used as a heating surface, for example in a holding furnace, electric smoothing iron etc.

A knife, especially a knife for surgical purposes, can be provided with a blade comprising a ceramic layer on at least a part of its outer surface, preferably with plasma electrolytic oxidation, with a relatively thin metallic core. When applying electric current to the knife it increases its temperature. When applying the knife as a surgery knife blood vessels are closed by the hot knife. This reduces surgery risks.

An iron can be provided with a heater element according to the present specification, preferably shaped as a plate or a similar shape. Preferably, the plate is on one side provided with the ceramic coating after which at least a part of the metal, preferably titanium or another suitable metal, is removed, for example using electrochemical machining. This enables effective control of heat production.

The present specification further also relates to a method for manufacturing a heater element and/or device as described herein, the method comprising the steps of:
providing a conductor of a resistance heating metal; and
performing plasma electrolytic oxidation in a plasma electrolytic oxidation chamber and provide a porous ceramic layer on the conductor.

The method provides the same effects and advantages as described for the heater element and/or the device. The method provides effective means to heat a fluid. The heater comprises a conductor with a ceramic layer that is provided using plasma electrolytic oxidation. Plasma electrolytic oxidation is preferably used as it enables control of the porosity and/or thickness of the ceramic layer.

In embodiments, in use, the heater reaches a temperature in the range of 50-750° C., preferably 100-500° C., more preferably 100-400° C., even more preferably 100-200° C., and most preferably 120-180° C. As shown, at these temperatures a good atomisation and/or vaporisation of the delivery fluid can be achieved.

In an example of a plasma oxidation process, the thickness of the ceramic layer is controlled by controlling the voltage, duration of the process, current density, electrolyte concentration and composition.

In embodiments, the conductor of the heater is provided as a valve metal, preferably titanium.

In an embodiment according to the present specification, the conductor is provided as a spiralled metal wire, wherein the wire is provided with the ceramic layer. The spiralled heater may be provided with its central axis substantially in the longitudinal direction of the fluid path.

In embodiments, the ceramic layer is provided with a porosity such that the fluid is transferred to the vicinity of the conductor by the ceramic layer. In an example of a plasma oxidation process, the porosity of the ceramic layer is controlled by controlling the voltage and the duration of the process. In embodiments, the ceramic layer is provided with a porosity in the range of 10-80%, preferably 15-50%, more preferably 20-30%, and most preferably the porosity is about 25%.

Optionally, after providing the ceramic layer on one side of the conductor, at least a part of the conductor material is removed, preferably with the use of electrochemical machining. This enables control of the thickness of the metal layer and, therefore, control of the resistance and heat production.

### BRIEF DESCRIPTION OF THE DRAWINGS

Further advantages, features and details of the specification are elucidated on the basis of embodiments thereof wherein reference is made to the accompanying drawings, in which:

FIG. 1 A shows an E-cigarette provided with a heater element according to one embodiment of the specification;

FIG. 1 B shows a device provided with a heater element according to another embodiment of the specification;

FIG. 1 C shows a device provided with a heater element according to another embodiment of the specification;

FIG. 1 D shows a device provided with a heater element according to another embodiment of the specification;

FIG. 1 E shows a device provided with a heater element according to another embodiment of the specification;

FIG. 2 A shows a configuration of a heater element according to one embodiment of the specification;

FIG. 2 B shows a configuration of a heater element according to one embodiment of the specification;

FIG. 2 C shows a configuration of a heater element according to one embodiment of the specification;

FIG. 2 D shows a configuration of a heater element according to one embodiment of the specification;

FIG. 2 E shows a configuration of a heater element according to one embodiment of the specification;

FIG. 2 F shows a configuration of a heater element according to one embodiment of the specification;

FIG. 2 G shows a configuration of a heater element according to one embodiment of the specification;

FIG. 2 H shows a configuration of a heater element according to one embodiment of the specification;

FIG. 2 I shows a configuration of a heater element according to one embodiment of the specification;

FIG. 2 J shows a configuration of a heater element according to one embodiment of the specification;

FIG. 2 K shows a configuration of a heater element according to one embodiment of the specification;

FIG. 2 L shows a configuration of a heater element according to one embodiment of the specification;

FIG. 2 M shows a configuration of a heater element according to one embodiment of the specification;

FIG. 2 N shows a configuration of a heater element according to one embodiment of the specification;

FIG. 2 O shows a configuration of a heater element according to one embodiment of the specification;

FIG. 2 P shows a configuration of a heater element according to one embodiment of the specification;

FIG. 2 Q shows a configuration of a heater element according to one embodiment of the specification;

FIG. 2 R shows a configuration of a heater element according to one embodiment of the specification;

FIG. 2 S shows a configuration of a heater element according to one embodiment of the specification;

FIG. 2 T shows a configuration of a heater element according to one embodiment of the specification;

FIG. 2 U shows a configuration of a heater element according to one embodiment of the specification;

FIG. 2 V shows a configuration of a heater element according to one embodiment of the specification;

FIG. 3 A shows a setup of a plasma electrolytic oxidation chamber to produce an embodiment of a heater element described herein;

FIG. 3 B shows a cross section of the setup of the plasma electrolytic oxidation chamber of FIG. 3 A;

FIG. 4 shows the Voltage as function of time in the manufacturing of the heater element in the chamber of FIG. 3 A; and

FIG. 5 shows a heater element according to the specification.

### DETAILED DESCRIPTION

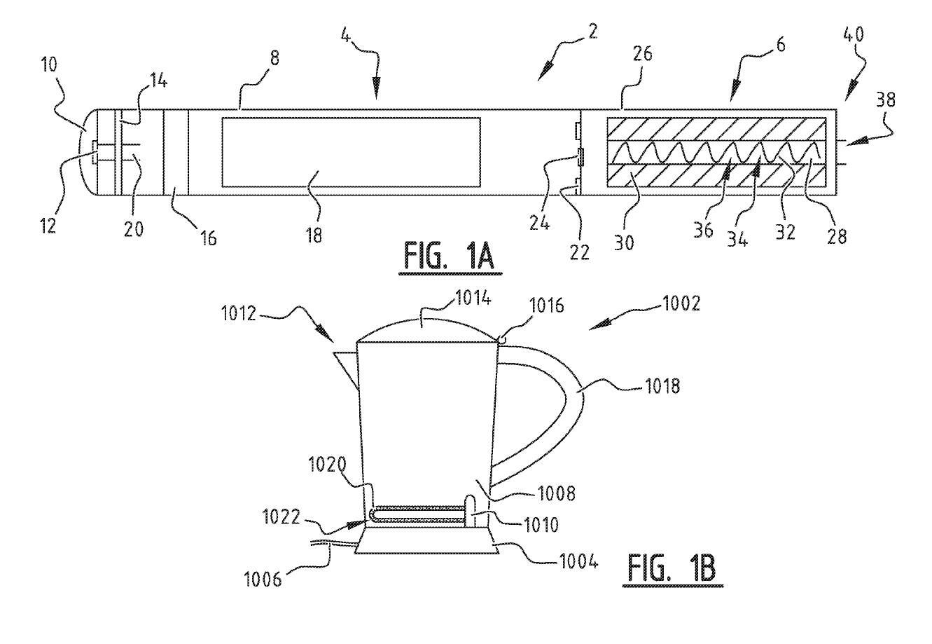

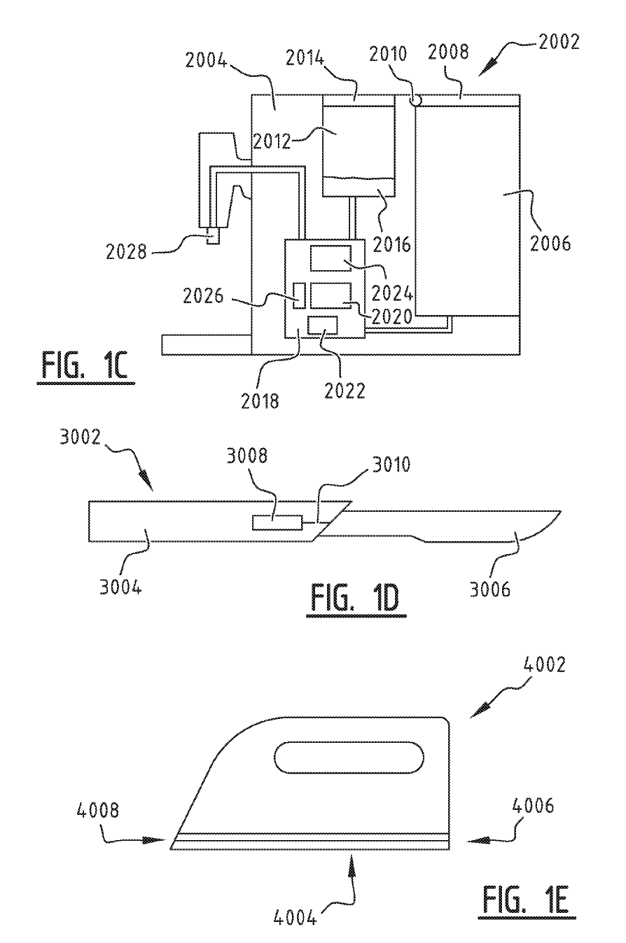

E-cigarette 2 (FIG. 1A) comprises battery assembly 4 and atomizer assembly 6. In the illustrated embodiment atomizer assembly 6 is disposable. It will be understood that the specification can also be applied to systems with other configuration and that the illustrated embodiments are for exemplary purposes only. Details, including connections between components, that are known to the skilled person from conventional E-cigarettes have been omitted from the illustration to reduce the complexity of the drawing.

Battery assembly 4 comprises housing 8, (LED) indicator 10 with air inlet 12, air flow sensor 14, circuit 16 and battery 18. Air from inlet 12 is provided with air path 20 to sensor 14. Circuit 16 comprises an electronic circuit board that is connected to the relevant components of system 2. Battery 18 can be a rechargeable battery including the required connections to enable recharging. Battery assembly 4 has air inlets 22 and connector 24 to connect battery assembly to atomizer assembly 6.

Atomizer assembly 6 comprises housing 26 with air path 28 that is surrounded with buffer 30 comprising the E-liquid (for example a mixture of glycerol, propylene glycol, nicotine). Buffer material may include wicking material such as silica, cotton, etc.) or buffer 30 can be provided by other buffer means. In the illustrated embodiment heater element 32 is provided at or around the perimeter of air path 28. In one of the preferred embodiments heater element 32 comprises a wire of metallic titanium core 34 with ceramic titanium oxide layer 36 around metallic core 34. The E-liquid is absorbed and/or adsorbed in the porous ceramic layer. Wire 32 is heated by passing an electric current through metallic titanium core 34. Wire 32 is heated and the E-liquid is evaporated and/or atomized. The mixture is provided to outlet 38 of air path 28 at mouth piece 40.

Heater 32 achieves an improved temperature control and the ability to control the amount of E-liquid evaporating in time by varying the characteristics of the porous ceramic layer 36, such as thickness, size of pores, and porosity.

When inhaling at outlet 38 an under pressure in air paths 20, 28 is achieved. Air is sucked in through inlets 12, 22. Sensor 14 detects an air flow and circuit board 16 sends an indication signal to indicator 10. Battery 18 provides electricity to heater 32 that heats the E-liquid supplied from buffer 30 and vaporizes and/or atomizes the liquid such that a user may inhale the desired components therein.

In the illustrated embodiment heater 28 has its longitudinal axis substantially parallel to air path 28. It will be understood that other configurations are also possible in accordance with the specification.

Cooker 1002 (FIG. 1B) for boiling water comprises base station 1004 with feeder cable 1006. Container 1008 is connectable with connector 1010 to station 1004. Container 1008 comprises outlet 1012, cover 1014 that is connected with hinge 1016 to container 1004, and handle 1018. Cooker 1002 further comprises heater element 1020 capable of heating the water in container 1008. The surface of heater element 1020 is provided with ceramic layer having pores 1022. In use, pores 1022 act as initiators for bubbles when water is boiling. Preferably, in the plasma electrolytic oxidation pore size, distribution and variation of the ceramic layer of heater element 1020 is specified in accordance with the specification of the heater element's use.

Coffee machine 2002 (FIG. 1C) comprises housing 2004 provided with water reservoir 2006, cover 2008 that is hingedly connected with hinge 2010 to housing 2004, bean reservoir 2012 with bean cover 2014 and mill 2016, and coffee making unit 2018. Unit 2018 comprises heater element 2020, controller 2022, mixer 2024 and pressure pump 2026. Coffee is provided at outlet 2028. In embodiments heater element 2020 comprises a tube that on the inside is provided with the ceramic layer. This achieves a controllable heating process with reduced temperature variation as compared to conventional coffee machines.

Surgery knife 3002 (FIG. 1D) comprises handle 3004 and blade 3006. Blade 3006 is provided with a metallic core and a porous ceramic layer on at least part of its surface. Blade 3006 can be heated using energy from battery 3008 that is connected to blade 3006 with connector 3010. By providing blade 3006 that can be heated vessels, for example blood vessels, will be substantially closed by the heated blade. This reduces safety risks.

Iron 4002 (FIG. 1E) comprises heater 4004 that is shaped as a plate. Heater 4004 comprises partly removed metal layer 4006 and ceramic layer 4008. Optionally, in use, heater 4004 comes into direct contact with the clothing, for example.

Several embodiments of a heater element according to the specification will be illustrated. These embodiments can be applied to the earlier described devices and also to other devices.

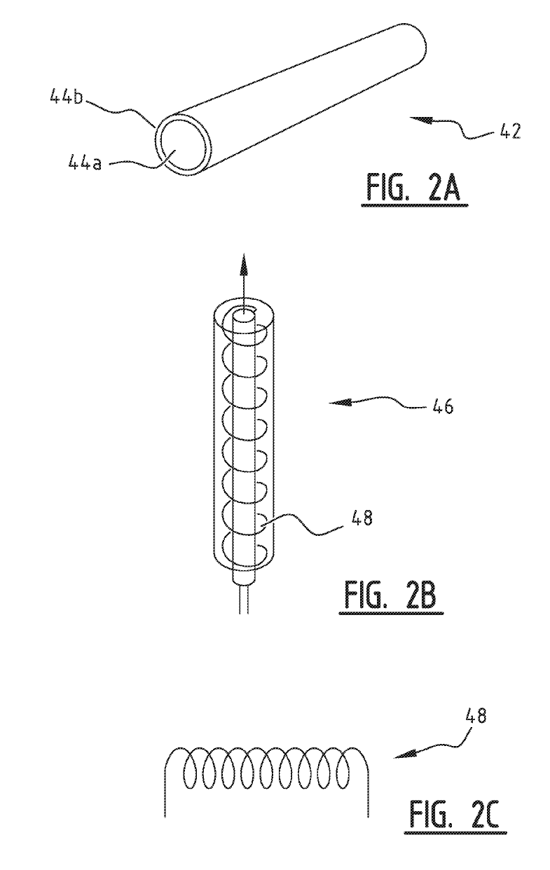

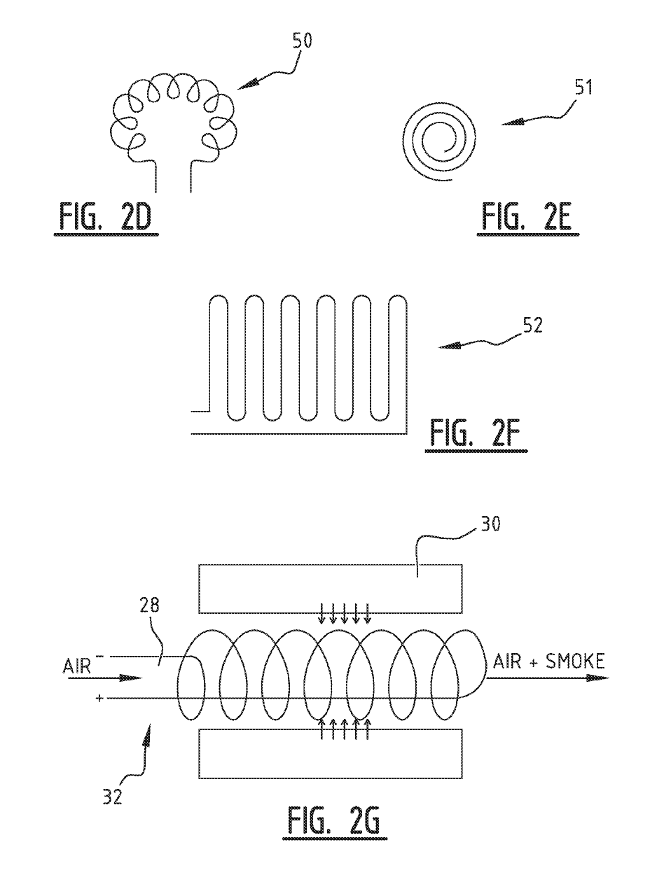

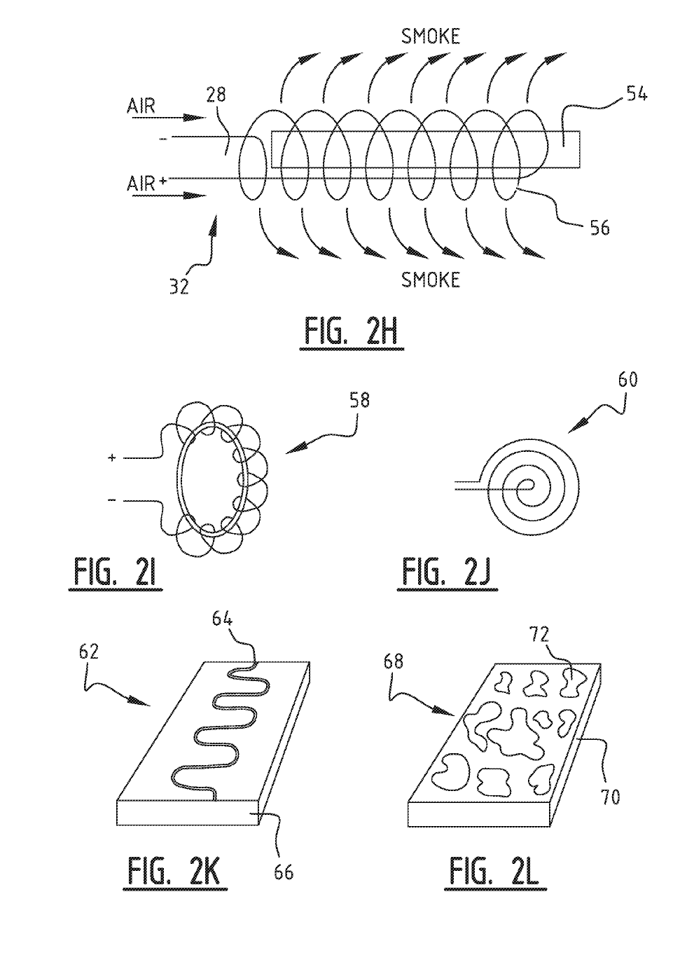

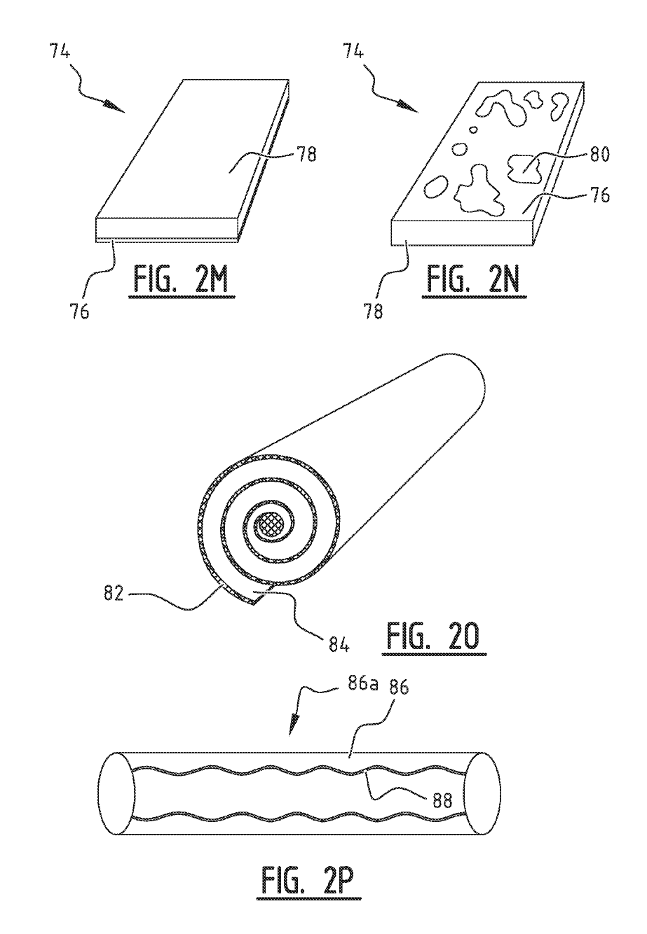

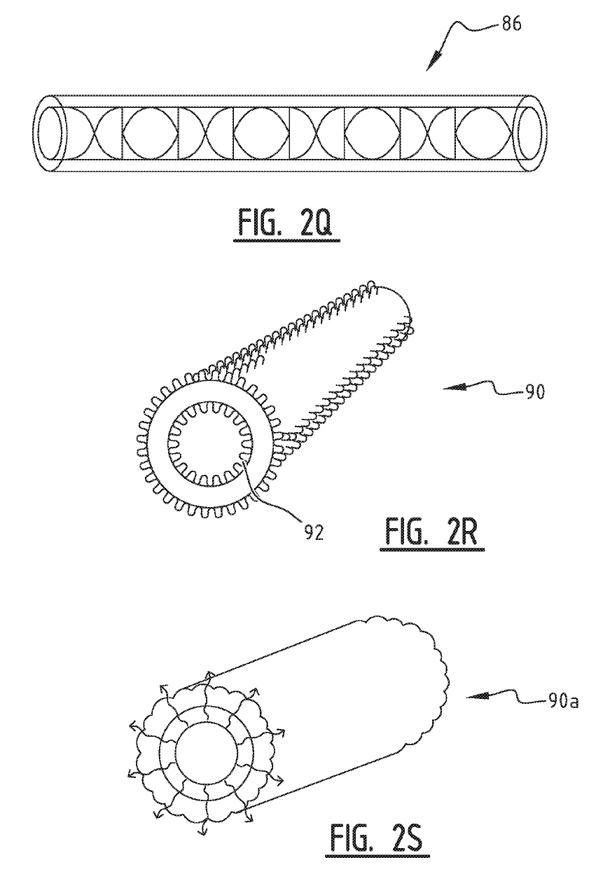

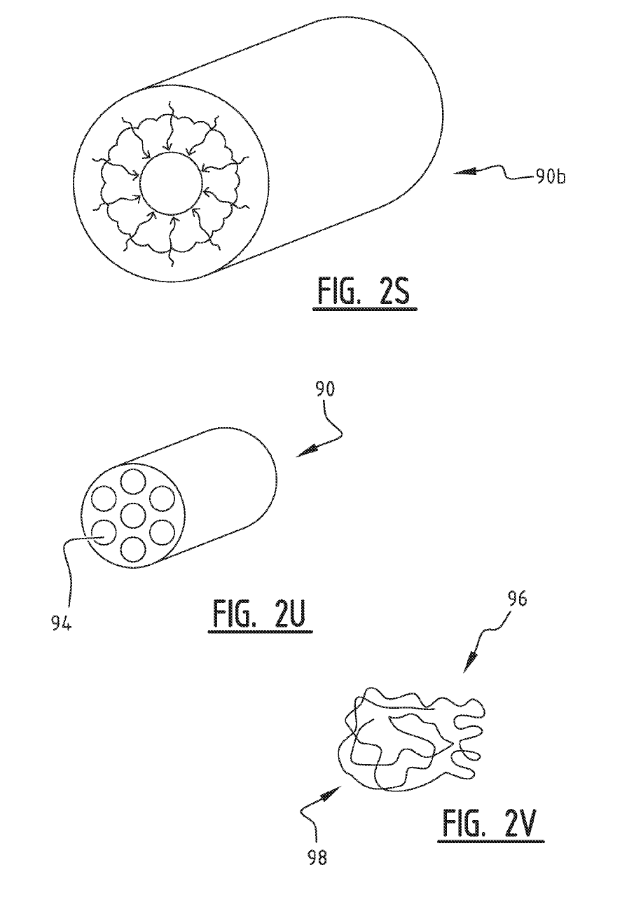

Heater 42 (FIG. 2A) comprises a resistance heating material 44a as conductor and porous ceramic layer 44b. Heater 46 (FIG. 2B) is wound as a solenoid 48 (FIG. 2C) similar to heater 28 as illustrated in FIG. 1. In an alternative configuration heater 50 is configured as a toroid (FIG. 2D), or flat coil 51 (FIG. 2E), or flat spiral 52 (FIG. 2F), for example.

In the illustrated embodiment of system 2 buffer 30 is provided around air path 28 and heater 32 (see also FIG. 2G). In an alternative embodiment liquid reservoir 54 is provided inside the solenoid of heater 56 (FIG. 2H).

Further alternative configurations include heater 58 (FIG. 2I) wound as toroid structure with liquid inside toroid structure and air flow around toroid structure, and heater 60 (FIG. 2J) as a flat coil. Also, heater 62 (FIG. 2K) may comprise a layer of path of resistance heating material 64 as conductor on coated porous ceramic layer 66, or alternatively heater 68 may comprise a conductor layer 70 with coated porous ceramic elements or spots 72 provided thereon (FIG. 2L). Alternatively, heater 74 comprises conductor layer 76 and ceramic layer 78 (FIG. 2M), and optionally additional ceramic spots 80 (FIG. 2N). Another embodiment comprises porous ceramic layer 82 with conductor 84 wound in a spiral configuration (FIG. 2O).

Other embodiments include conductor tube 86 with static mixing form 86a coated with ceramic layer 88 (FIGS. 2P and 2Q). As a further alternative, conductor 90 is a tube (FIG. 2R) with a ceramic layer 92. Tube 90a can be filled with liquid on the inside and having air flow on the outside (FIG. 2S) or tube 90b has air flow on the inside and liquid buffer on the outside (FIG. 2T). Optionally, a ceramic layer is provided on the inside and the outside of tube 90. Also, tube 90 may comprise a number of smaller tubes or wires 94 with resistance heating material and ceramic material (FIG. 2U). A further alternative configuration (FIG. 2V) involves resistance heating metallic foam or sponge 96 coated with porous ceramic material 98.

The disclosed embodiments for heater 32 provide examples of heaters according to the specification that can be applied to systems 2.

Heater elements according to the specification are preferably manufactured using plasma electrolytic oxidation. As an example, for illustrative reasons only, below some manufacturing methods for some of the possible configurations for the heater element according to the specification will be disclosed.

In a first embodiment of the heater element, plasma electrolytic oxidation of titanium wire that is directly connected to an anode is performed.

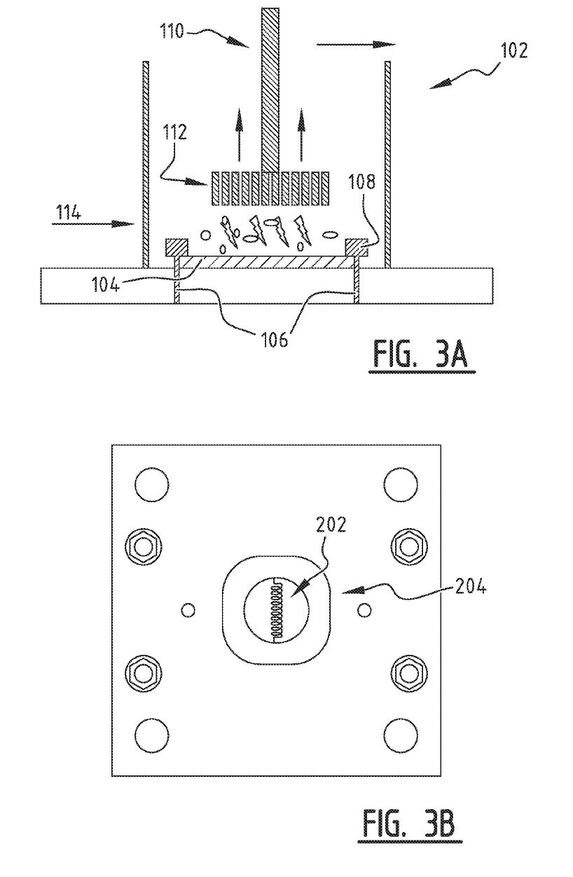

For the plasma electrolytic oxidation use is made of a plasma electrolytic chamber 102 (FIG. 3 A). Work piece 104 is connected to the anode 106. Work piece 104 is clamped/fixed between two screws or clamps 108 that are connected to the ground/earth (anode 104) of a power supply. In the illustrated embodiment cathode 110 comprises stainless steel honeycomb electrode 112 that, in use, is placed at close distance above work piece 104. Electrolyte 114 flows between electrode 112 and anode 106, and effectively flows upwards through honeycomb electrode 112 together with the produced oxygen and hydrogen. Electrolyte effluent 116, together with the hydrogen and oxygen, is then cooled and optionally returned to chamber 102. In the illustrated embodiment the temperature of electrolyte 114 increases from around 11° C. entering plasma electrolytic oxidation chamber 102 to 25° C. exiting chamber 102 and is then cooled off using a heat exchanger (not shown).

In the illustrated chamber 102 two power supplies (Munk PSP family) are connected in series: one of 350 Volt and 40 Ampere and a second of 400 Volt and 7 Ampere resulting in a maximum of 750 Volt and 7 Ampere with resulting maximum power of 5.25 kW. The power supplies can be connected directly to anode 106 and cathode 110 resulting in direct current (DC) operation of the plasma. An optionally added switching circuit provides the option to operate the plasma with DC pulses. The frequency of the pulses can be set between DC and 1 kHz and different waveforms can be chosen (block, sine, or triangle). Plasma electrolytic oxidation is preferably performed in a pulsed current mode with a frequency (on-off) of about 1000 Hz, preferably with the current set at a fixed value and the voltage increases in time as a result of growing of the porous oxide layer. Current between 1 and 7 Ampere can be used to produce a ceramic layer.

To produce a heater element according to the specification, in chamber 102 titanium wire 202 (FIG. 3 B) is placed as work piece 104 on top of a titanium plate 204 that is connected to the stainless steel anode. Optionally, the anode is directly connected to wire 202. The electrolyte comprised 8 g/l NaSiO3*5H₂O and 15 g/l (NaPO3)₆. Titanium wire is used made from titanium grade 1, with a diameter of 0.5 mm and 60 cm in length. The wire is coiled and connected to the anode. A potential higher than 500 volts is applied between the anode and cathode resulting in micro arc discharges on the surface of the titanium wire. On the surface of the wire, the metallic titanium is oxidized to titanium oxide with addition of silicates and phosphates from the electrolyte. The metallic layer is converted to a porous ceramic layer containing titanium oxides, phosphates and silicates. This results in a heater element 302 according to the specification.

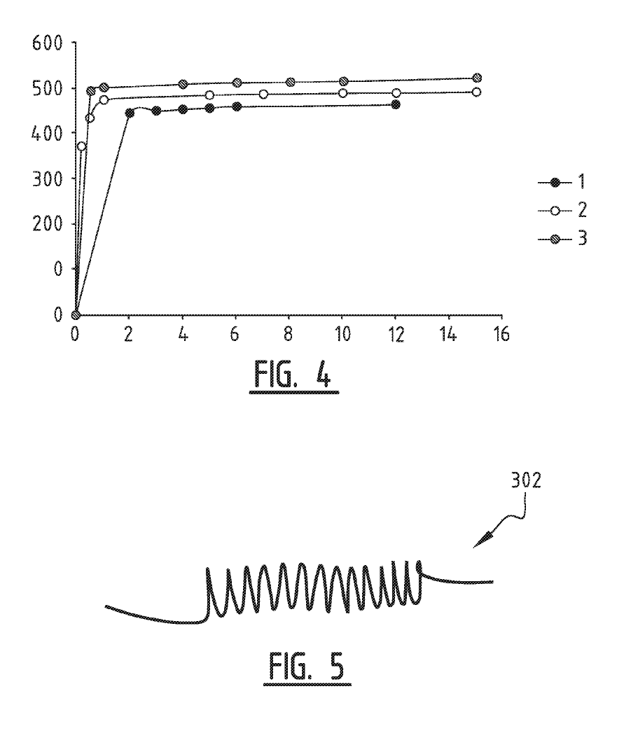

Three experiments were done: 1) 0.5 Ampere for 15 minutes, 2) 1 Ampere for 15 minutes and 3) 2 Ampere for 15 minutes. The mass and diameter of the wire was measured before and after plasma electrolytic oxidation. The wire was placed in water for 5 minutes and the mass was measured as an indication of the amount of water adsorbed on the wire. The voltage as a function of time of the three different current settings can be seen in FIG. 4, and some further material information before and after oxidation is presented in Table 1.

TABLE 1
Material information

| | Weight | | |
|---|---|---|---|
| | (mg) | | |
| | 1 | 2 | 3 |
| Before PEO (mg) | | 525.49 | 529.82 |
| After PEO (mg) | 528.37 | 539.42 | 548.71 |
| After heating (mg) | 528.09 | 539.23 | 547.67 |
| After 5 min in water | 675.7 | 692.23 | 705.42 |
| (mg) | | | |
| Thickness (μm) | 36 | 71 | 113 |
| Volume geads (ml) | 0.15 | 0.15 | 0.16 |
| Volume oxide layer | 0.45 | 0.51 | 0.59 |
| (ml) | | | |
| Porosity (%) | 32.71 | 29.87 | 26.73 |

Ceramic wires were manufactured at different process conditions, including with 5 Ampere (wire 1) and 1 Ampere (wire 2) for processing time of an hour. The results are shown in Table 2.

TABLE 2
Thickness of ceramic layer porosity and adsorption of
two ceramic titanium wires

| | Time + | Ceramic | | | |
|---|---|---|---|---|---|
| | current | thickness | Porosity | Adsorption | Resistance |
| Wire 1 | 1 hr @ 5 A | 55 μm | 45% | 21 μl | 1.4 Ω |
| Wire 2 | 1 hr @ 1 A | 30 μm | 50% | 13 μl | 1.3 Ω |

Wire 1: Before plasma electrolytic oxidation (PEO)
L=0.5 m, D=0.500 mm, R=1.2Ω, R_{calculated}=2.44 Ω/m, Adsorption (water)=4 μl
Wire 1: After PEO (5 A for 60 minutes)
L=0.5 m, D=0.610 mm, R=1.3-1.4Ω, Adsorption (water)=21 μl, Porosity=44%

### Wire 2: Before PEO:

L=0.5 m, D=0.500 mm, V=9.8 e−8 m³, m=4.2992 e−4 kg, ρ=4379 kg/m³
Wire 2: After PEO (1 A for 60 minutes)
L=0.5 m, D=0.5610 mm, V=1.236 e−8 m³, m=4.512 e−4 kg, ρ=3650 kg/m³, m_{oxide layer}=2.13 e−5 kg, V_{oxide layer}=2.56 e−8 m³, M_{estimate without porosity}=4.452 e−5 kg, Porosity=50%, Calculated adsorption=12.8 μl

It will be understood that for alternative wires other conditions would apply. For example, for a wire having a diameter of 0.1 mm R_{calculated}=61 Ω/m. Such wire with a length of 6.5 cm will give a resistance of 4Ω. With an oxide thickness of 100 μm an amount of 1.3 μl is adsorbed. 150 μm gives 3.1 μl and 200 μm gives 5.4 μl.

The experiments illustrate the manufacturing possibilities of the heater element for the system according to the present specification.

Further experiments have been conducted to produce other configurations for the heater. In one such further experiment a metal foil, preferably an aluminium foil, was used as starting material on which a porous metal (aluminium) oxide layer is provided, preferably in a plasma electrolytic chamber that is described earlier. Table 3 shows measured values of plasma electrolytic oxidation with constant current at 5 ampere for 9 minutes. Aluminium foil of 13 μm thickness was oxidized with a resulting thickness of aluminium oxide of 13 μm.

TABLE 3
Voltage, current, temperature of electrolyte going
in the plasma electrolytic oxidation chamber (Tin) and going
out the plasma electrolytic oxidation chamber (Teff)
for constant current of 5 A.

| t min. | Voltage V | Current A | Tin ° C. | Teff ° C. |
|---|---|---|---|---|
| 0.167 | 434 | 5 | | |
| 0.5 | 447 | 5 | | |
| 1 | 461 | 5 | | |
| 2 | 476 | 5 | 10.1 | 18.8 |
| 4 | 487 | 5 | 10.9 | 20.4 |
| 6 | 499 | 5 | 11.3 | 21.4 |
| 9 | 515 | 5 | | |

Table 4 shows the reproducibility of the process.

TABLE 4
Voltage, current, temperature of electrolyte going
in the plasma electrolytic oxidation chamber (Tin) and going
out the plasma electrolytic oxidation chamber (Teff)
for constant current of 5 A.

| | Voltage | | | |
|---|---|---|---|---|
| t min. | V | Current A | Tin ° C. | Teff ° C. |
| 0.167 | 435 | 5 | | |
| 0.5 | 448 | 5 | | |
| 1 | 460 | 5 | | |
| 2 | 474 | 5 | 11.3 | 19.7 |
| 4 | 488 | 5 | | |
| 6 | 495 | 5 | | |
| 8 | 505 | 5 | | |

Table 5 shows the voltage and current for plasma electrolytic oxidation of aluminium foil at constant current of 2 A. Result was a 13 μm thick aluminium oxide layer.

TABLE 5
Voltage and current of plasma electrolytic oxidation
with constant current of 2 A.

| t min. | Voltage V | Current A |
|---|---|---|
| 1 | 380 | 2 |
| 2 | 415 | 2 |
| 3 | 429 | 2 |
| 4 | 437 | 2 |
| 5 | 443 | 2 |
| 6 | 448 | 2 |
| 7 | 452 | 2 |

Table 6 shows the voltage and current of the plasma electrolytic oxidation of aluminium foil with pulsed constant current of 1 kHz at 5 Ampere.

TABLE 6
Voltage and current of pulsed constant current of 1 kHz

| T min. | Voltage V | Current A |
|---|---|---|
| 0.167 | 470 | 5 |
| 0.5 | 485 | 5 |
| 1 | 491 | 5 |
| 2 | 502 | 5 |
| 4 | 514 | 5 |
| 6 | 523 | 5 |

In a further experiment, plasma electrolytic oxidation was used to provide a porous, flexible and elastic ceramic layer of >70 μm on titanium foil. Plasma electrolytic oxidation grows a titanium oxide layer which is known to be ceramic (TiO₂). Electrolyte was used with 8 g/l Na₂SiO₃*5H₂O (Natrium metasilicate pentahydrate) and 15 g/l (NaPO₃)₆ (Natrium hexametaphosphate). The electrolyte is pumped into the reaction chamber to act as the electrolyte and as a coolant. Titanium foil was used from titanium grade 2 with a thickness of 124 μm. In the manufacturing process the voltage increases as a function of time. This increase signifies an increased resistance and can possibly be explained by the growth of the titanium oxide (TiOx) layer. A thicker TiOx layer acts like an insulating layer between the metal and electrolyte. The resulting Voltage development in time can be seen in Table 7.

TABLE 7
Voltage and current as function of time for production of
ceramic layer on titanium foil with plasma electrolytic oxidation

| Time | | |
|---|---|---|
| min. | Voltage V | Current A |
| 0.166667 | 435 | 6 |
| 0.5 | 510 | 6 |
| 1 | 540 | 6 |
| 2 | 551 | 6 |
| 3 | 553 | 6 |
| 4 | 554 | 6 |
| 5 | 556 | 6 |
| 6 | 556 | 6 |
| 7 | 557 | 6 |
| 10 | 557 | 6 |

The resulting foil structure can be processed further involving electrochemical machining. For example, use can be made of dissolution of Titanium grade 2 to make perfect squared shaped channels. With electrochemical machining (ECM) Titanium grade 2 is locally dissolved in a very controlled manner until the ceramic layer is reached. The finished result has to be well defined channels with squared edges and no residue on top of the ceramic layer. The ECM process is used with a cathode with the inverse shape of the product placed on top of a Titanium plate that serves as the anode. A potential is placed between the cathode and anode causing the anode to dissolve.

Electrolyte concentration is 5 M NaNO₃. Current density can be varied from 20-150 A/cm². The best results were realized with current densities of >60 A/cm². Current is operated in a pulsed mode with the time the current is on and off can be varied. Best results were realized with on/off ratio of 16-80 and pulse on from 0.05 until 10 ms and pulse off from 1 ms until 160 ms. This additional processing step may also be applied to other configurations for the heater.

The above described experiments illustrate the possibility to manufacture the different configurations of the heater element and to implement such configuration in an E-cigarette, cooker, coffee machine and knife, for example.

The present specification is by no means limited to the above described embodiments thereof. The rights sought are defined by the following claims, wherein the scope of which many modifications can be envisaged.

1. A heater element for heating a fluid, comprising:
a heater of a resistance heating metal that is provided in, at or close to a fluid path configured for heating fluid,
wherein the heater comprises a conductor that is provided with a porous ceramic layer.

2. The heater element according to claim 1, wherein the ceramic layer is provided on or at the conductor with plasma electrolytic oxidation.

3. The heater element according to claim 1, wherein the ceramic layer has a thickness in the range of 5-300 μm.

4. The heater element according to claim 1, wherein the heater comprises a spiralled metal wire as the conductor, wherein the wire is provided with the ceramic layer.

5. The heater element according to claim 4, wherein the metal wire comprises titanium.

6. The heater element according to claim 4, wherein the spiralled heater has a central axis that is provided substantially in the longitudinal direction of the fluid path.

7. The heater element according to claim 1, wherein the ceramic layer is provided with a porosity.

8. The heater element according to claim 7, wherein the ceramic layer has a porosity in the range of 10-80%.

9. (canceled)

10. The heater element according to claim 1, wherein the conductor has a plate shape and is on one side provided with the ceramic layer, and wherein at least part of the metal layer has been removed.

11. A device comprising a heater element according to claim 1.

12. The according to claim 11, wherein the device is one of: a cooker for boiling liquid, an E-cigarette, a coffee machine, a knife, and an iron.

13. An insulated conductor comprising a metal conductor that is provided with a ceramic layer as an electrically insulating layer.

14. A method for manufacturing a heater element and/or device, the method comprising the steps of:
providing a conductor of a resistance heating metal; and
performing plasma electrolytic oxidation in a plasma electrolytic oxidation chamber to deposit a porous ceramic layer on the conductor.

15. The method according to claim 14, wherein the heater is configured to reach, in use, a temperature in the range of 50-750° C.

16. The method according to claim 14, further comprising the step of removing at least a part of the conductor material, wherein the conductor is shaped as a plate with on one side being provided with the porous ceramic layer.

17. The method according to claim 14, wherein after providing the ceramic layer on one side of the conductor, at least a part of the conductor material is removed with the use of electrochemical machining.

18. The method according to claim 15, further comprising the step of removing at least a part of the conductor material, wherein the conductor is shaped as a plate with on one side being provided with the porous ceramic layer.

19. The method according to claim 18, wherein after providing the porous ceramic layer on one side of the conductor, at least a part of the conductor material is removed with the use of electrochemical machining.

20. A method for heating a fluid, wherein:
a heater of a resistance heating metal is provided in, at or close to a fluid path configured for heating fluid,
wherein the heater comprises a conductor that is provided with a porous ceramic layer;
wherein the porous ceramic layer is provided on or at the conductor with plasma electrolytic oxidation;
wherein the heater comprises a spiralled metal wire as the conductor, wherein the wire is provided with the porous ceramic layer; and
wherein the metal wire comprises titanium.

21. The device according to claim 11, further comprising a power increasing circuit configured for providing a power increase when the heater is switched on.
